(19) United States
(12) Patent Application Publication
(10) Pub. No.: US 2020/0318585 A1
(43) Pub. Date: Oct. 8, 2020

(54) INERTIAL PRECLEANER WITH VARIABLE ASPIRATION FLOWRATE CONTROL VIA AMBIENT DUST CONCENTRATION SENSOR INPUT

(71) Applicant: CUMMINS FILTRATION IP, INC., Columbus, IN (US)

(72) Inventors: Peter K. Herman, Stoughton, WI (US); Christopher E. Holm, Madison, WI (US)

(73) Assignee: CUMMINS FILTRATION IP, INC., Columbus, IN (US)

(21) Appl. No.: 16/300,928

(22) PCT Filed: May 13, 2016
(86) PCT No.: PCT/US2016/032379

§ 371 Date: Nov. 12, 2018

(51) Int. Cl. F02M 35/022; B01D 45/16; B01D 46/24; B01D 50/00; B04C 3/06; B04C 9/00; B04C 11/00; B01D 46/44; F02M 35/02; F02M 35/024; F02M 35/06; F02M 35/08

(52) U.S. Cl. CPC F02M 35/0223; B04C 2009/005; B01D 46/2411; B01D 50/002; B04C 3/06; B04C 9/00; B04C 11/00; B01D 46/442; F02M 35/0216; F02M 35/024; F02M 35/06; F02M 35/08; B01D 2279/60; B04C 2009/002; B01D 45/16

(57) ABSTRACT

An air intake system having an air filter and a cyclonic pre-cleaner is described. The cyclonic pre-cleaner includes a plurality of fins that cause the air flowing through the pre-cleaner to go from a substantially axial flow to a substantially swirling flow. As the air flow through the pre-cleaner increases, the air is swirled at a faster rate, and some contaminant particles in the air will be forced out of the flow of air before reaching the air filter. The air intake system includes a blower unit having a motor, an impeller, and a controller. The blower unit structured to selectively draw more air through the air intake system to increase the flow of air through the pre-cleaner thereby increasing the efficiency of the pre-cleaner.

### TECHNICAL FIELD

The present application relates to filtration systems for use with internal combustion engines or the like.

### BACKGROUND

Internal combustion engines generally combust a mixture of fuel (e.g., gasoline, diesel, natural gas, etc.) and air. Prior to entering the engine, intake air is typically passed through a filter element to remove contaminants (e.g., particulates, dust, water, etc.) from the intake air prior to delivery to the engine. Some air filtration systems utilize a pre-cleaner to remove at least a portion of the contaminants prior to the intake air passing through a filter element. The use of a pre-cleaner can reduce the amount of contaminants entering the filter element thereby increasing the life of the filter element and reducing the amount of contaminants ingested by the internal combustion engine.

One type of pre-cleaner is a cyclonic pre-cleaner that causes the intake air to form a cyclonic flow (i.e., a swirling flow) which ejects larger contaminants from the intake air prior to passing through the filter element. Generally, the efficiency of a cyclonic pre-cleaner (i.e., the dust extraction efficiency) improves with increased air flow through the pre-cleaner and also improves with increased extracted airflow (often referred to as pre-cleaner aspiration flow). Existing systems utilize exhaust education to create a venturi effect pump or a pressured air supply to create a jet pump to increase aspiration air flow extracted from the cyclonic pre-cleaner. However, these pumps include extra ducting that can be prone to plugging, corrosion, and general failure. Additionally, these types of pumps often rely on other internal combustion engine systems, which can be parasitic on engine fuel economy and may not function at low engine air flowrates.

Further, engine operating conditions can drastically change. For example, ambient atmospheric dust concentration for engine air intake systems can abruptly vary by approximately five orders of magnitude (e.g., depending on transitioning between paved roads and gravel or dirt roads). Thus, the additional pre-cleaner aspiration is not always needed and results in wasted power to increase the pre-cleaner aspiration.

### SUMMARY

One example embodiment relates to an air filtration system. The system includes an air filter assembly. The system further includes a cyclonic pre-cleaner positioned upstream of the air filter assembly in an air flow direction. The cyclonic pre-cleaner comprises a pre-cleaner housing and is structured to cause air flowing through the cyclonic pre-cleaner to transition from a substantially axial flow to a substantially swirling flow. The system includes a blower unit in fluid communication with the cyclonic pre-cleaner through a conduit. The conduit has a first end coupled to the pre-cleaner housing and a second end coupled to an air inlet of the blower unit such that when the blower unit is active, the blower unit draws air through the pre-cleaner housing.

Another example embodiment relates to a method. The method includes receiving, by a controller through a sensor input, a sensor feedback signal from a dust concentration sensor structured to indicate a concentration of dust entering an inlet of a pre-cleaner housing of a pre-cleaner of an air filtration system. The method further includes determining, by a motor control circuit of the controller, that an aspiration adjustment to increase an airflow through the pre-cleaner housing is needed to achieve proper pre-cleaning efficiency of the pre-cleaner based at least in part on the sensor feedback signal. The method includes, in response to determining that an aspiration adjustment to increase airflow through the pre-cleaner is needed, adjusting, by the motor control circuit, a speed of a motor of a blower unit in fluid communication with the pre-cleaner housing to achieve the aspiration adjustment.

A further example embodiment relates to an air filtration system controller. The controller includes a sensor input circuit structured to receive a sensor feedback signal from a dust concentration sensor structured to indicate a concentration of dust entering an inlet of a pre-cleaner housing of a pre-cleaner of an air filtration system. The controller includes a motor control circuit structured to determine that an aspiration adjustment to increase an airflow through the pre-cleaner housing is needed to achieve proper pre-cleaning efficiency of the pre-cleaner based at least in part on the sensor feedback signal. The motor control circuit is further structured to, in response to determining that an aspiration adjustment to increase airflow through the pre-cleaner is needed, adjust a speed of a motor of a blower unit in fluid communication with the pre-cleaner housing to achieve the aspiration adjustment.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 shows a schematic view of an air intake system for an internal combustion engine according to an example embodiment.

FIG. 2 shows an example graph comparing pre-cleaner efficiency against the percent scavenge (aspiration) and air flow rate through the pre-cleaner of FIG. 1.

FIG. 3 shows a schematic view of the controller of the air intake system of FIG. 1.

FIG. 4 shows a flow diagram of a method of operating an air intake system for an internal combustion engine according to an example embodiment.

### DETAILED DESCRIPTION

Referring to the figures generally, an air intake system having an air filter and a cyclonic pre-cleaner are described. The cyclonic pre-cleaner includes a plurality of fins that cause the air flowing through the pre-cleaner to go from a substantially axial flow to a substantially swirling flow. As the air flow through the pre-cleaner increases, the air is swirled at a faster rate, and some contaminant particles in the air will be forced out of the flow of air before reaching the air filter. The air intake system includes a blower unit 122 having a motor 124, an impeller 126, and a controller 128. The blower unit structured to selectively draw more air through the air intake system to increase the discharged flow of air (i.e., scavenge flow) through the pre-cleaner thereby increasing the efficiency of the pre-cleaner.

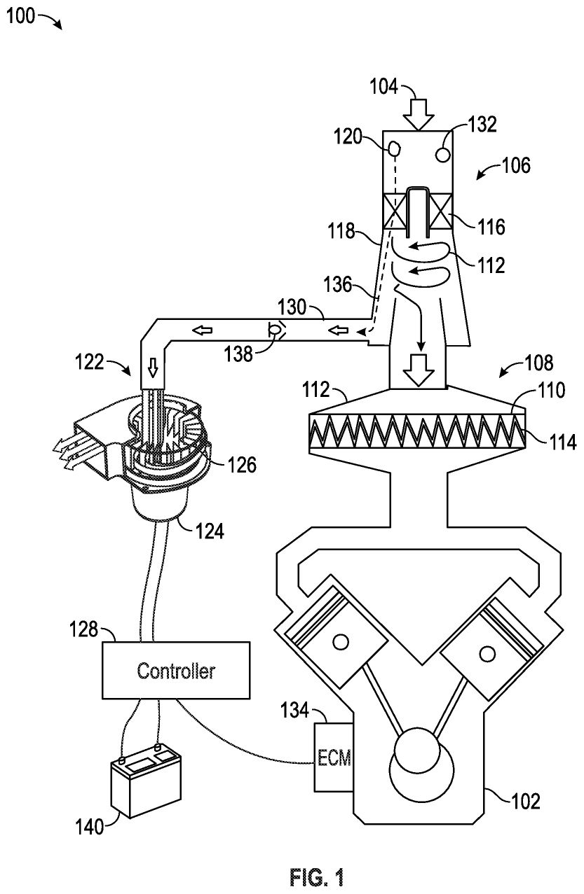

Referring to FIG. 1, a schematic view of an air intake system 100 for an internal combustion engine 102 is shown according to an example embodiment. The air intake system 100 intakes air 104, cleans/filters the air 104, and provides cleaner air to the internal combustion engine 102. The internal combustion engine 102 may be, for example, a diesel internal combustion engine. The air intake system 100 cleans the air 104 by passing the air 104 through a pre-cleaner 106 and an air filter assembly 108. The pre-cleaner 106 and the air filter assembly 108 remove contaminants (e.g., dust, water, etc.) from the air prior to the air being passed to the internal combustion engine 102.

The air filter assembly 108 includes a removable filter cartridge 110 positioned within an air filter housing 112. In some arrangements, the filter cartridge 110 is a panel filter cartridge. In other arrangements, the filter cartridge 110 may be a cylindrical filter cartridge. The removable filter cartridge 110 includes filter media 114 that captures contaminants in the air 104. The filter media 114 may include any of cellulose-based filter media, glass filter media, fibrous filter media, nanofiber filter media, or the like. The air filter housing 112 includes an inlet (upstream of the filter element 110) and an outlet (downstream of the filter element) that supplies cleaned air 114 to the internal combustion engine 102. The inlet of the air filter housing 112 receives air 104 from the pre-cleaner 106.

The pre-cleaner 106 is positioned upstream of the air filter assembly 108 in the air flow direction. The pre-cleaner 106 is an inertial separation pre-cleaner. The pre-cleaner 106 cyclonic pre-cleaner that includes a plurality of fins 116 positioned within a pre-cleaner housing 118. The plurality of fins 116 cause the air 104 to go from a substantially axial flow to a substantially swirling flow (e.g., as designated by flow path 112). As used herein, “substantially axial flow” describes air flow through the air intake system 100 that has a significantly larger flow direction component in an axial direction with respect to the conduit the air is flowing through than a circumferential direction such that the circumferential component is insignificant (e.g., the axial component is an order of magnitude or more greater than the circumferential component). “Substantially swirling flow” describes air flow through the air intake system 100 that has a significant flow direction component in the circumferential direction relative to the axial direction (e.g., the axial component is on the same order of magnitude as the circumferential component). As the air flow through the pre-cleaner 106 increases, the air 104 swirl velocity increases in a proportional manner. If the air 104 is swirling fast enough, some contaminant particles 120 will be forced radially outward towards the pre-cleaning housing 118 and out of the stream of air 104 because the contaminant particles 120 have a higher mass than the air 104 and experience centrifugal separation from the air 104. The pre-cleaner housing 118 includes an inlet (upstream of the plurality of fins 116) and an outlet (downstream of the plurality of fins 116). The inlet of the pre-cleaner housing 118 receives air from the ambient environment, and the outlet of the pre-cleaner housing 118 provides pre-cleaned air 104 to the inlet of the air filter housing 112.

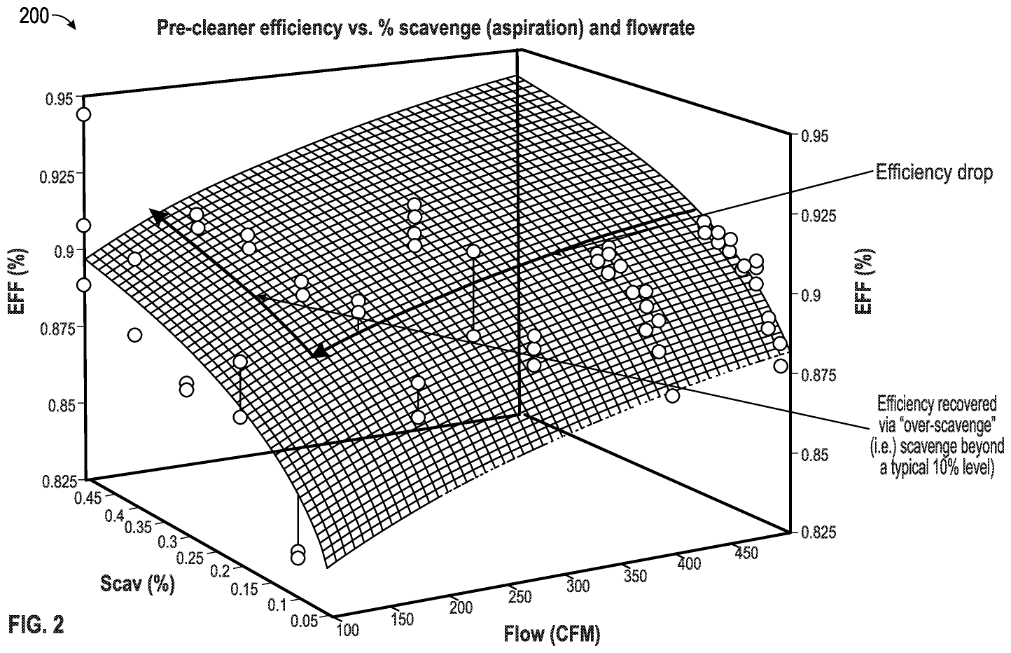

Under many engine operating conditions (e.g., low idle engine speed, vehicle low-speed cruise conditions, etc.), the air flow through the pre-cleaner 106 is not sufficient to cause the air 104 to swirl fast enough to separate the contaminant particles 120. This situation may be referred to as “efficiency droop” (i.e., loss of pre-cleaner efficiency at low engine air flowrates), which causes poor pre-cleaner particle separation. FIG. 2 shows a graph 200 comparing pre-cleaner efficiency against the percent scavenge (aspiration) and air flow rate through the pre-cleaner 106 of the air intake system 100. As shown in the graph, pre-cleaner efficiency drops at lower air flow rates and at low aspiration rates.

Referring again to FIG. 1, the air intake system addresses the efficiency droop problem through a blower unit 122 having a motor 124, an impeller 126, and a controller 128. The blower unit 122 is in fluid communication with the pre-cleaner housing 118 via the conduit 130. A first end of the conduit 130 is fluidly coupled to the pre-cleaner housing 118 at a position that is downstream of the plurality of fins 116 in the air flow direction and upstream of the outlet of the pre-cleaner housing 118. A second end of the conduit 130 is coupled to an air inlet of the blower unit 122. Accordingly, when the blower unit 122 is activated, the blower unit 122 draws air through the pre-cleaner housing 118 thereby increasing the air flow through the pre-cleaner housing 118, which increases the efficiency of the pre-cleaner 106. Separated contaminant particles 120 are also drawn out of the pre-cleaner housing 118 and through the conduit 130 when the blower unit 122 is activated. When the internal combustion engine 102 is drawing enough air through the intake system 100 to create the pre-cleaning effect, the blower unit 122 is turned off to avoid wasted power draw.

As described in further detail below, the controller 128 is structured to selectively activate and control the speed of the motor 124 based on feedback from a dust concentration sensor 132 and from the engine control module 134 (ECM) associated with the internal combustion engine 102. The motor 124 spins the impeller 126. The impeller 126 draws air through the conduit 130, which in turn draws air through the pre-cleaner housing 118 thereby increasing the air flow through the pre-cleaner housing 118. As the air flow through the pre-cleaner housing increases, contaminant particles 120 separate from the air stream and exit the pre-cleaner housing through the conduit 130 (e.g., as shown by path 136). In some arrangements, the conduit 130 includes a one-way check valve 138 that prevents air 104 from flowing backwards through the conduit 130 and into the pre-cleaner housing 118 thereby preventing air 104 from bypassing the pre-cleaner 106. The blower unit 122 is powered by a battery 140. The controller 128 may vary the amount of power provided to the motor 124 from the battery 140. In some arrangements, the battery 140 is the same battery used to power various components of the internal combustion engine 102 (e.g., a starter motor). The battery may be a rechargeable battery that is charged by an alternator of the internal combustion engine 102. In further arrangements, the battery 140 is eliminated and the power for the blower unit 122 and the controller 128 is provided directly by the internal combustion engine (e.g., via an alternator) or from an alternating current source in arrangements where the internal combustion engine powers a generator.

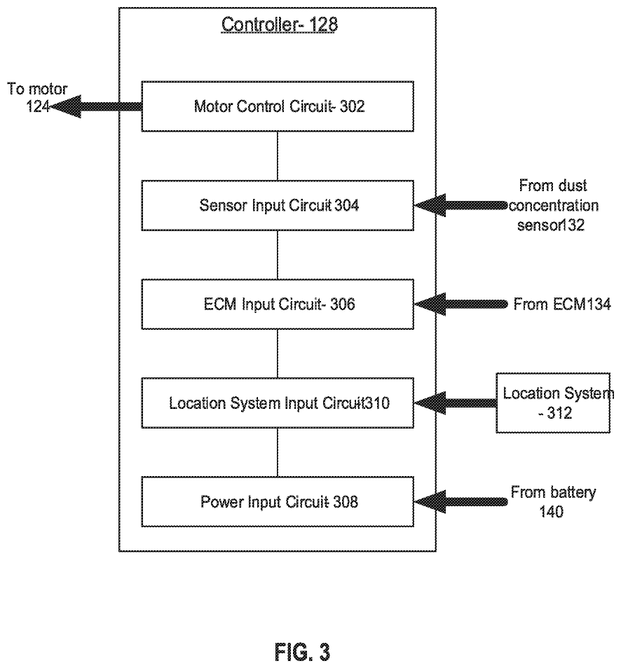

A schematic view of the controller 128 is shown in FIG. 3. The motor control circuit 302 includes a processor (e.g., a general-purpose processor, an application specific integrated circuit (ASIC), one or more field programmable gate arrays (FPGAs), a digital signal processor (DSP), a group of processing components, or other suitable electronic processing components) and memory (e.g., RAM, NVRAM, ROM, Flash Memory, hard disk storage, etc.). The controller 128 includes a motor control circuit 302 structured to selectively provide power to the motor 124 from the battery 140 based on at least one of feedback from the dust concentration sensor 132 and feedback from the ECM 134. In some arrangements, the motor control circuit 302 is structured to vary the amount of power provided to the motor 124.

The controller 128 includes a sensor input circuit 304, an ECM input circuit 306, and a power input circuit 208. Each of the sensor input circuit 304, the ECM input circuit 306, and the power input circuit 308 provide input to the motor control circuit 202. The sensor input circuit 304 is in electrical communication with the dust concentration sensor 132. The sensor input circuit 304 may be an analog or digital input. The dust concentration sensor 132 provides a feedback signal to the controller 128 indicating a concentration of ambient dust entering the inlet of the pre-cleaner housing 118. In some arrangements, the dust concentration sensor 132 is an optical sensor (e.g., a light scattering sensor, an extinction sensor, etc.). In some arrangements, the dust concentration sensor 132 is positioned within the pre-cleaner housing 118. In further arrangements, the dust concentration sensor 132 is positioned adjacent to the inlet of the pre-cleaner housing 118. The ECM input circuit 306 is in electrical communication with the ECM 134. Through the ECM input circuit 206, the ECM 134 provides engine operating parameters (e.g., engine speed, engine temperature, engine fuel consumption, engine air consumption, power demanded, fueling information, intake airflow information, boost ratios, etc.) to the controller 128. In some arrangements, the ECM 134 receives input from the dust concentration sensor 132. In such arrangements, the ECM input circuit 306 also receives the feedback signal from the dust concentration sensor 132 via the ECM 134, and the sensor input circuit 304 may be combined with the ECM input circuit 306. In some arrangements, the ECM input 126 communicates with the ECM 134 via a vehicle data bus (e.g., a controller area network vehicle bus (“CANBUS”), a J1939 data link, etc.). The power input circuit 308 connects the controller 128 to the battery 140. Accordingly, the controller 128 receives operational power from the battery 140 via the power input circuit 308. In some arrangements, the controller 128 also provides operational power to the motor 124 from the battery 140 via the power input circuit 308 and the motor control circuit 302.

In some arrangements, the controller 128 includes a location system input circuit 310 structured to receive input from a location system 312. The location system 312 provides feedback regarding a location of a vehicle powered by the internal combustion engine 102. In some arrangements, the location system 312 includes a GPS receiver coupled to the vehicle and a maps database. The maps database includes information regarding various locations, including road locations, road types (e.g., paved, gravel, dirt, number of lanes, etc.), and known environmental conditions (e.g., that the vehicle is in a known dusty location, such as in the desert). The location system 312 may power a navigation system of the vehicle. Through the location system input circuit 310, the location system 312 provides current vehicle location information to the controller 128. The current vehicle location information includes an indication as to whether the vehicle is on a paved road, on a gravel road, on a dirt road, or off road. If the current vehicle location is a known dusty location (such as a desert area), the location system 312 can also indicate that to the controller 128 via the location system input circuit 310. Based at least in part on the current vehicle location information the controller 128 can control the speed of the motor 124. For example, if the vehicle is traveling down a dirt or gravel road or if the vehicle is in a known dusty location, the controller 128 can increase the speed of the motor 124 to increase aspiration and air flow through the pre-cleaner 106. In some arrangements, the location system 312 is used in place of the dust concentration sensor 132. In such arrangements, the sensor input circuit 304 may be eliminated from the controller 128. In other arrangements, the location system 312 supplements the dust concentration sensor 132. In these arrangements, the controller includes both the sensor input circuit 304 and the location system input circuit 310.

Generally, the controller 128 is structured to change the speed of the motor 124, including turning the motor 124 on and off, based on feedback from the dust concentration sensor 132 and engine operating parameters from the ECM 134. While various circuits with particular functionality are shown in the figures, it should be understood that the controller 128 may include any number of circuits for completing the functions described herein. For example, the activities of multiple circuits may be combined as a single circuit, additional circuits with additional functionality may be included, etc. Further, it should be understood that the controller 128 may further control and/or monitor other internal combustion engine systems beyond the scope of the present disclosure. For example, the controller 128 and the ECM 134 may be combined as a single unit (in which case any “communication” between the module and the engine control module 108 is an internalized communication). The operation of the controller 128 (and the air intake system 100) is described in greater detail below with respect to FIG. 3.

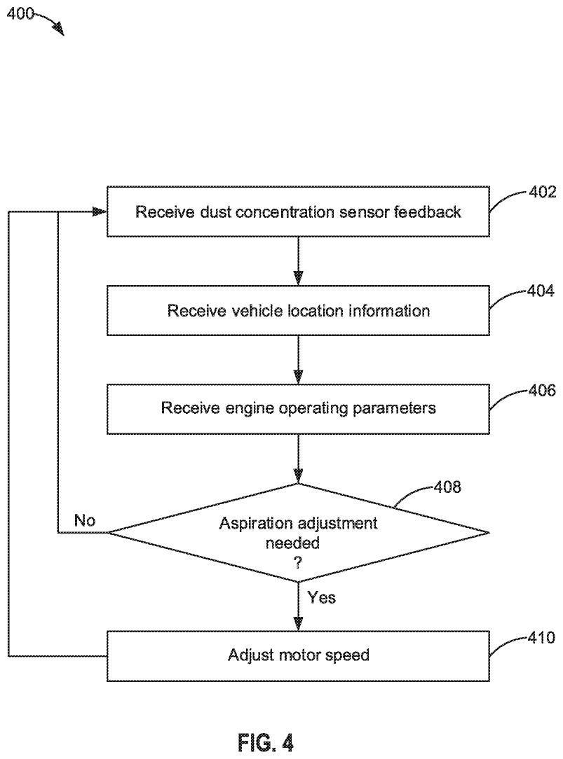

Referring to FIG. 4, a flow diagram of a method 400 of operating the air intake system 100 is shown according to an example embodiment. The method 400 is performed by the controller 128 (e.g., via the motor control circuit 202). The method 400 begins when dust concentration sensor feedback is received at 402. The controller 128 receives a sensor feedback signal from the dust concentration sensor 132 via the sensor input circuit 304. The feedback signal indicates a concentration of ambient dust entering the inlet of the pre-cleaner housing 118.

In some arrangements, instead of or in addition to receiving the sensor feedback signal from the dust concentration sensor 132 at 402, vehicle location information may be received from the location system 312 via the location system input circuit 310 at 404. As discussed above with respect to the location system 312, the vehicle location information may include any of an indication as to whether the vehicle is on a paved road, the vehicle is on a gravel road, the vehicle is on a dirt road, the vehicle is off road, or that the vehicle is in a known dusty location.

Engine operating parameters are received at 406. The controller 128 receives engine operating parameters from the ECM 134 via the ECM input circuit 206. The engine operating parameters may include any of engine speed, intake air flowrate through the engine 102, engine temperature, engine fuel consumption, power demanded, boost ratios, and the like. In some arrangements, the controller 128 does not control the blower unit 122 based on the engine operating parameters. In such arrangements, 406 is skipped.

The controller 128 determines if an aspiration adjustment (i.e., airflow increase or decrease through the pre-cleaner housing 118) is needed for the air intake system 100 at 408. The controller 128 determines if an aspiration adjustment is needed based at least in part on one of the feedback signal from the dust concentration sensor 132, the engine operating parameters received from the ECM 134, or the vehicle location information received from the vehicle location system 312. In some arrangements, the controller 128 determines that an aspiration adjustment is needed also based in part on both the engine operating parameters received from the ECM 134 and the feedback signal from the dust concentration sensor 132. In some arrangements, the controller 128 analyzes the input data based on a time-weighted average of engine operating parameters or dust concentration feedback or utilization of an averaging period to dampen rapid fluctuations in dust concentration or engine operating parameters to avoid excessive changes in the speed of the motor 124, which increases the life of the motor 124. The controller 128 can determine one of three situations exists: (1) no adjustment is needed, (2) the speed of the motor 124 needs to be increased (e.g., from zero to a positive speed, or from a first speed to a second, faster speed), or (3) the speed of the motor 124 needs to be decreased (e.g., from a positive speed to zero, or from a first speed to a second, slower speed).

If no aspiration adjustment is needed, the method 400 returns to 402, and the method 400 repeats. In some arrangements, the no aspiration adjustment determination is made if the intake air 104 is clean and/or if the air flowrate through the pre-cleaner housing 118 is sufficient to cause an appropriate level of pre-cleaning.

If an aspiration adjustment is needed, the motor speed is adjusted at 410. In some arrangements, the controller 128 increases the aspiration through the pre-cleaner housing 118 by increasing the speed of the motor 124 by supplying more power to the motor 124 from the battery 140. In such arrangements, the controller 128 determines that more pre-cleaning assist is required (e.g., if the air 104 is dirty or if the internal combustion engine 102 is not drawing a high enough air flow rate through the pre-cleaner housing 118 to create the pre-cleaning effect on its own). Accordingly, the controller 128 can increase the speed of the motor 124 by turning on the motor 124 or supplying more power to the motor 124. For example, if the air 104 entering the pre-cleaner housing 118 is dirty (e.g., contains a high amount of contaminant particles 120) or if the internal combustion engine 102 is operating in known dusty conditions (e.g., on a gravel or dirt road, off road, in a known dusty location, etc.), and the air flow through the pre-cleaner housing 118 is not large enough to cause a pre-cleaning effect, the controller 128 will determine that the motor 124 needs to be activated to increase the air flow through the pre-cleaner housing 118 thereby inducing a greater pre-cleaning effect. In other arrangements, the controller 128 decreases the aspiration through the pre-cleaner housing 118 by decreasing the speed of the motor 124 by supplying more power to the motor 124 from the battery 140. In such arrangements, the controller 128 determines that less pre-cleaning assist is required (e.g., if the air 104 is cleaner or if the internal combustion engine 102 is drawing a high enough air flow rate through the pre-cleaner housing 118 to create the pre-cleaning effect on its own). Accordingly, the motor 124 can have its speed decreased or entirely shut off.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

References herein to the positions of elements (e.g., “top,” “bottom,” “above,” “below,” etc.) are merely used to describe the orientation of various elements in the FIGURES. It should be noted that the orientation of various elements may differ according to other example embodiments, and that such variations are intended to be encompassed by the present disclosure.

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Some of the functional units described in this specification have been labeled as circuits, in order to more particularly emphasize their implementation independence. For example, a circuit may be implemented as a hardware circuit comprising custom very-large-scale integration (VLSI) circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

As mentioned above, circuits may also be implemented in machine-readable medium for execution by various types of processors, such as the processor of the controller 128 of FIGS. 1 and 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

The computer readable medium (also referred to herein as machine-readable media or machine-readable content) may be a tangible computer readable storage medium storing computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. As alluded to above, examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. As also alluded to above, computer readable program code embodied on a computer readable signal medium may be transmitted using any appropriate medium, including but not limited to wireless, wireline, optical fiber cable, Radio Frequency (RF), or the like, or any suitable combination of the foregoing. In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on a computer (such as via the controller 128 of FIGS. 1 and 2), partly on the computer, as a stand-alone computer-readable package, partly on the computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An air filtration system comprising:
an air filter assembly;
a cyclonic pre-cleaner positioned upstream of the air filter assembly in an air flow direction, the cyclonic pre-cleaner comprising a pre-cleaner housing and structured to cause air flowing through the cyclonic pre-cleaner to transition from a substantially axial flow to a substantially swirling flow, the cyclonic pre-cleaner comprises a plurality of fins positioned within the pre-cleaner housing; and
a blower unit in fluid communication with the cyclonic pre-cleaner through a conduit having a first end coupled to the pre-cleaner housing at a position that is downstream of the plurality of fins and a second end coupled to an air inlet of the blower unit such that when the blower unit is active, the blower unit draws air through the pre-cleaner housing.

2. The air filtration system of claim 1, wherein the blower unit comprises a motor and an impeller.

3. The air filtration system of claim 2, further comprising a controller structured to control a speed of the motor.

4. The air filtration system of claim 3, further comprising a dust concentration sensor structured to provide a feedback signal to the controller indicating a concentration of ambient dust entering an inlet of the pre-cleaner housing.

5. The air filtration system of claim 4, wherein the controller is structured to control the speed of the motor based at least in part on the feedback signal from the dust concentration sensor.

6. The air filtration system of claim 3, wherein the controller is structured to control the speed of the motor based at least in part on an engine operating parameter of an internal combustion engine that receives filtered air from the air filtration system.

7. The air filtration system of claim 6, wherein the controller is structured to receive the engine operating parameter from an engine control module of the internal combustion engine.

8. The air filtration system of claim 7, wherein the engine operating parameter is a speed of the internal combustion engine.

9. The air filtration system of claim 7, wherein the engine operating parameter is an intake air flowrate through the internal combustion engine.

10. The air filtration system of claim 1, further comprising a one-way check valve positioned between the first end of the conduit and the second end of the conduit.

11. (canceled)

12. A method comprising:
receiving, by a controller through a sensor input, a sensor feedback signal from a dust concentration sensor structured to indicate a concentration of dust entering an inlet of a pre-cleaner housing of a pre-cleaner of an air filtration system, the pre-cleaner comprises a plurality of fins positioned within the pre-cleaner housing;
determining, by a motor control circuit of the controller, that an aspiration adjustment to increase an airflow through the pre-cleaner housing is needed to achieve proper pre-cleaning efficiency of the pre-cleaner based at least in part on the sensor feedback signal; and
in response to determining that an aspiration adjustment to increase airflow through the pre-cleaner is needed, adjusting, by the motor control circuit, a speed of a motor of a blower unit in fluid communication with the pre-cleaner housing at a position that is downstream of the plurality of fins to achieve the aspiration adjustment.

13. The method of claim 12, further comprising receiving, by the controller via an engine control module input, an engine operating parameter of an internal combustion engine from an engine control module, the internal combustion engine receives cleaned air from the air filtration system.

14. The method of claim 13, wherein determining that an aspiration adjustment is needed is based at least in part on the engine operating parameter.

15. The method of claim 13, wherein the engine operating parameter is a speed of the internal combustion engine.

16. The method of claim 13, wherein the engine operating parameter is an intake air flowrate through the internal combustion engine.

17. The method of claim 13, wherein the internal combustion engine powers a vehicle.

18. The method of claim 17, further comprising receiving, by the controller through a location system input, location information from a location system, the location information relating to a current location of the vehicle, wherein determining that the aspiration adjustment to increase the airflow through the pre-cleaner housing is needed to achieve proper pre-cleaning efficiency of the pre-cleaner is based at least in part on the location information.

19. The method of claim 12, further comprising supplying, by the motor control circuit, electric power to the motor to turn the motor on in response to determining that an aspiration adjustment to increase airflow through the pre-cleaner is needed.

20. The method of claim 12, further comprising cutting, by the motor control circuit, electric power to the motor to turn the motor off in response to determining that an aspiration assist through the pre-cleaner is no longer needed.

21. An air filtration system controller comprising:
a sensor input circuit structured to receive a sensor feedback signal from a dust concentration sensor structured to indicate a concentration of dust entering an inlet of a pre-cleaner housing of a pre-cleaner of an air filtration system, the pre-cleaner comprises a plurality of fins positioned within the pre-cleaner housing; and
a motor control circuit structured to:
determine that an aspiration adjustment to increase an airflow through the pre-cleaner housing is needed to achieve proper pre-cleaning efficiency of the pre-cleaner based at least in part on the sensor feedback signal, and
in response to determining that an aspiration adjustment to increase airflow through the pre-cleaner is needed, adjust a speed of a motor of a blower unit in fluid communication with the pre-cleaner housing at a position that is downstream of the plurality of fins to achieve the aspiration adjustment.

22. The air filtration system controller of claim 21, further comprising an engine control module input circuit structured to receive an engine operating parameter of an internal combustion engine from an engine control module, the internal combustion engine receives cleaned air from the air filtration system.

23. The air filtration system controller of claim 22, wherein the motor control circuit determines that an aspiration adjustment is needed is based at least in part on the engine operating parameter.

24. The air filtration system controller of claim 22, wherein the engine operating parameter is a speed of the internal combustion engine.

25. The air filtration system controller of claim 22, wherein the engine operating parameter is an intake air flowrate through the internal combustion engine.

26. The air filtration system controller of claim 22, wherein the internal combustion engine powers a vehicle.

27. The air filtration system controller of claim 26, further comprising a location system input circuit structured to receive location information from a location system of the vehicle, the location information relating to a current location of the vehicle, wherein the motor control circuit determines that the aspiration adjustment to increase the airflow through the pre-cleaner housing is needed to achieve proper pre-cleaning efficiency of the pre-cleaner is based at least in part on the location information.

28. The air filtration system controller of claim 21, wherein the motor control circuit is further structured to supply electric power to the motor to turn the motor on in response to determining that an aspiration adjustment to increase airflow through the pre-cleaner is needed.

29. The air filtration system controller of claim 21, wherein the motor control circuit is further structured to cut electric power to the motor to turn the motor off in response to determining that an aspiration assist through the pre-cleaner is no longer needed.
